(19) United States
(12) Patent Application Publication
(10) Pub. No.: US 2006/0246881 A1
(43) Pub. Date: Nov. 2, 2006

(54) Call control system and method for targeting calls

(75) Inventors: Thomas Winkler, Vancouver (CA); William Pui, Richmond (CA)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/121,190

(22) Filed: Apr. 28, 2005

(51) Int. Cl. H04M 3/42

(52) U.S. Cl. 455/415

(57) ABSTRACT

The invention relates to a call controlling. In a method for controlling targeting calls, a targeting call is detected, which targeting call is pre-screened according to a set of rules, and whether a caller of said targeting call is not otherwise allowed, an importance of said targeting call is determined, by means of which importance call diverting is decided. The invention relates also to a device, to a calling device, to a system and to a computer program product.

### FIELD OF THE INVENTION

This invention relates to telecommunications. In particular this invention relates to a call controlling for targeting calls.

### BACKGROUND OF THE INVENTION

One of main characteristics of the mobile communication terminal (referred here as “mobile phones”) is the feature that allows the mobile phone to be easily carried from place to place. This feature has, however, pointed also situations where the use of the mobile phone is not that acceptable or desirable, even though it is possible. With mobile phones users are reachable at any time in any location, which can be disruptive in some situations, if e.g. the phone rings at an inappropriate time and place or talking to the phone disturbs other events, e.g. meeting, family dinner, etc.

When receiving a call the user makes a decision to answer or not to answer to the call. The decision is eased by the feature which allows the user to screen who is calling. The caller information is shown on a display of the mobile phone in the form of a caller number or—if the caller information is found from a contact book in a mobile phone—a name of the caller.

There are also other solutions available in mobile phones to help controlling of incoming calls. For example, phone profiles allow different ringing types according to a profile in question. Thereby incoming calls can be set silent, whereby the user only sees who is calling, and not hear the ringing tone. In addition the calls can be filtered according to profiles. This means that during a certain profile only certain callers are allowed whereas the others are rejected.

Even though these control features help at one point, still the problem of how to screen incoming phone calls and decide whether to accept them or not, based the reason for the call or importance of the call. Currently the only solution for that, is to answer the phone and talk to the caller and that is the one thing that usually disrupts certain situations.

### SUMMARY OF THE INVENTION

The aim of this invention is to provide a solution according to which controlling of targeting and incoming calls will become more effective. To achieve this aim a method, a device, a calling device, a computer program product and a system are provided. According to these, it is possible to interact with the caller and determine whether his/her reason for the call is important enough to put the call through.

In the method for controlling targeting calls a targeting call is pre-screened according to set of rules determined for the target device and an importance of said targeting call is determined, by means of which importance call diverting is decided.

The device for controlling communication, comprises means for pre-screening a targeting call according to a set of rules determined for said device, wherein said means are arranged to determine an importance of said targeting call, by means of which importance said means are configured to decide for call diverting.

The device for controlling communication comprises a call control system for pre-screening a targeting call according to a set of rules determined for said device, wherein said call control system is arranged to determine an importance of said targeting call, by means of which importance said call control system is configured to decide for call diverting.

The calling device comprises means for initiating a call and, as a response to the initiated call, for receiving a request for determining an importance of said call, whereby said calling device is capable of sending the determined importance as a response to the request.

The computer program product comprises computer readable instructions for controlling communication, wherein said instructions are configured to pre-screen a targeting call according to a set of rules and to determine an importance of said targeting call, by means of which importance said instructions are configured to decide for a call diverting.

The system for communication comprises at least a calling terminal and a receiving terminal and a communication network configured between them, said system further comprising means for pre-screening a call originating from said calling terminal according to a set of rules, said rules being determined for the receiving terminal, wherein said means are further arranged to determine an importance of said call, by means of which importance said means are configured to decide for call diverting.

This invention improves the prior art by allowing the classification of incoming calls by interaction with the caller. The solution according to invention gives more control for call acceptance than earlier. By means of the solution the call screening is automated but still without harming the user's desire and possibility to receive important calls.

The solution according to this invention can be implemented on the mobile phone side without requiring any changes on the mobile telecommunication network side or on the phone of the caller. Therefore any incoming calls are treated similarly when targeted to a phone in question. In addition, the solution can be implemented in the network side instead of mobile phone side.

### DESCRIPTION OF THE DRAWINGS

The invention is described in more detailed manner with help of examples illustrated by following figures, wherein

FIG. 1 illustrates a simplified example of method steps for carrying out one example of invention,

FIG. 2 illustrates a simplified block structure of one example of a communication device,

FIG. 3 illustrates a simplified example of a communication system, and

FIG. 4 illustration another example of a communication system.

### DETAILED DESCRIPTION OF THE INVENTION

The current invention is described by means of examples of different situations, where the call is received and how the call is controlled. In this description specific terms are used for a sake of clarity. These terms are intended to refer to the examples and figures, whereby they are not intended to unnecessarily define or limit the scope of the invention. “Mobile phone” refers to any wireless communication device that can be used for wireless communication, i.e. receiving and making calls or other contacts. Even though mobile phones are used in these examples, other communication terminals can be used instead. The term “call control system” refers to the current solution, particularly to the means that implements call control. The term “user” refers to a person operating with the wireless terminal and receiving the contacts, such as calls, whereby term “caller” refers to a person making the contact, e.g. a call. The term “incoming call” refers to a contact that is targeted to a mobile phone, wherein the call control is made. The term “targeting call” refers to a similar thing, but without making a difference as to where call control is made: targeting call is targeted to a mobile phone, but the call control can be made on a server's side or on the mobile phone's side.

In this description a solution for a call control system for mobile phones is described. The call control system can operate in the form of an interactive dialog with the caller, which interactive dialog can comprise voice or visual elements or both. For example, the call control system may act akin to an interactive answering machine or the call control system may provide a menu on a display of the calling terminal, wherefrom the caller can select a suitable option. The basic idea of the call control system is to accept the call on behalf of the user and to go through certain steps to determine whether it is appropriate for the user to accept the call, whether the call is important enough. This is done by interacting with the caller. If the call control system determines that the call is important enough to interrupt the user, it will make the phone ring and put the call through. Otherwise, it can reject the call or send it to voice mail. The call control system works like a secretary; it interacts with the caller, determines the urgency level of the call, and either takes a note/voice mail, or puts the call through. In other words, it makes the selection for the user. The call control system bases its determination on the current context of the user (for example location, profile, time, time zone), the identity of the caller (if known) based on caller ID and information in the contact directory on the phone and keypad or voice entries from the caller.

The following examples will present use cases for the operation of the inventive call control system.

### EXAMPLE 1

The user (called Joy Heading) is in an important meeting and has the phone set to silent profile. In this silent profile the phone will ring silently. When a phone call comes in from the caller, the phone does not ring. The user can see the name of the caller on the display. In this profile the call control system is turned on. The call control system is—in this example—configured to screen calls from any caller after three rings. Therefore after three silent rings, the call control system accepts the call and the caller hears a message: “Hello, you have reached Joy Heading. I am currently in a meeting and cannot take any calls. If you press 1 or stay on the line, you can leave me a voice message. Only in case your call is very urgent, press the star key twice and my phone will ring.”

### EXAMPLE 2

The user (called Mike Watson) is in an important meeting and has the phone set to meeting profile. The profile is profiled with timer according to starting time and ending times of the meeting. For example the profile can be set automatically on, when the meeting time is detected from a calendar and off, when the meeting ends according to the calendar. The profile can be set also manually by the user, e.g. that the following 60 minutes should be on meeting profile. In this profile the phone may ring silently or may beep once. When a phone call comes in from the caller, the user can see the name of the caller on the display. In the current profile the call control system is turned on. The call control system is—in this example—configured to screen calls from any caller immediately. Therefore after detecting the incoming call, the call control system accepts the call and the caller hears a message: “Hello, you have reached Mike Watson. I am currently in a meeting and cannot take any calls for 45 minutes. If you press 1 or stay on the line, you can leave me a voice message and I will call you back. Only in case your call is very urgent, press the star key twice and my phone will ring.” In this example the call control system acquires the profile timing from the timer and informs the caller about the meeting time. Therefore the caller can decide whether the reason for the call is important, and that it can or cannot wait 45 minutes.

### EXAMPLE 3

The user (called Heinz Gast) is travelling to another country with a different timezone and is currently asleep. The time in the country in question is 4:00 in the morning. The user forgot to switch off the phone or switch it to silent mode, whereby if any calls were arriving, they would be inconveniently alarmed. Meanwhile, in the user's home time zone, normal business hours are in effect and a delivery person wants to inform the user that a package is ready for pick-up. This call is not urgent and does not justify waking up the user at that time. Instead of the phone ringing immediately and waking up the user, the call control system picks up and the caller hears a message: “Hello, you have reached Heinz Gast. I am currently travelling and it is . . . 4:01 a.m. . . . local time. If you press 1 or stay on the line, you can leave me a voice message. Only in case your call is very urgent, press the star key twice and my phone will ring.” In this example the call control system acquires the time from e.g. a network. By comparing the network time to a mobile phone's time information it is possible to determine, that the user is travelling.

### EXAMPLE 4

The user (called Marie Ox) has had enough of telesellers, especially the ones who calls from an unknown number. The user's phone can be set to any profile, e.g. to general profile, wherein the phone will ring normally. A phone call comes in from the caller from an unknown number. In this situation the call control system can be turned on immediately after the unknown number is detected, whereby the call control system accepts the call and the caller hears a message: “Hello, you have reached Marie Ox from an unknown number. If you are selling something, please hang up, I am not interested. If you want to contact me with other issues, press 1 or stay on the line and you can leave me a voice message. Only in case your call is very urgent, press the star key twice and my phone will ring.”

### EXAMPLE 5

The user, Joy Heading, is again in an important meeting and has the phone set to silent profile. In this silent profile the phone will ring silently. When a phone call comes in from the caller, the phone does not ring audibly. The user can see the name of the caller on the display. In this profile the call control system is turned on. The call control system is—in this example—configured to screen calls from any caller after three rings. Therefore after three silent rings, the call control system accepts the call. In this example the call control system provides visual information to the display of the calling phone. As an example the visual information can comprise information concerning the situation of the recipient and further a menu for actions with which the caller can proceed. For example the menu can be formed of the following information:
The person you called is currently in a meeting. Select an urgency level for your call by using number buttons or arrow buttons:
   3 very urgent
   2 quick response needed
   1 answering machine

If the caller classifies the level, the user can be notified with that many beep sounds or the selection can be presented on a display of the user. According to selection “1” the call is directed to the answering machine.

Method

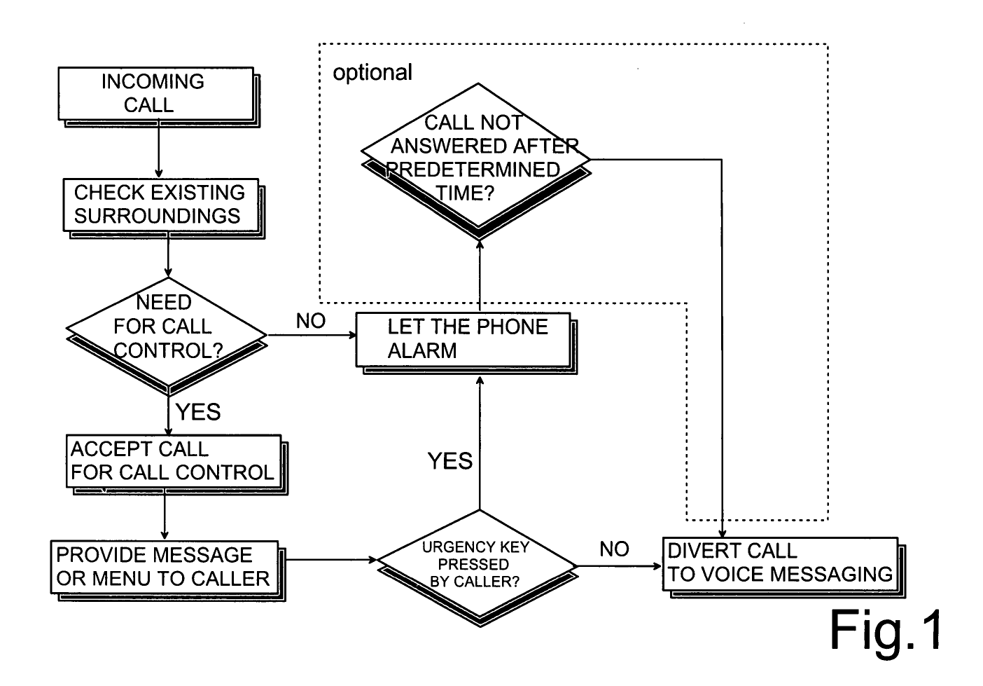

In FIG. 1 an example of method steps is illustrated. The method steps follow the steps of the previous examples, however in the FIG. 1 an optional feature is added compared to them. As in the previous examples, also in this example the phone continues alarming after a caller has pressed the urgency keybutton, e.g. star button. However, in this example the phone has been set to automatic call diverting to voice message after a predetermined time, e.g. 20 seconds, whereby if the user (recipient) is still not answering the call, the call is diverted to the voice messaging.

Implementation

The invention can be implemented as a computer program for mobile phones. For example the computer program can be in a call handling software that allows a user to deal with incoming calls by accepting them, by rejecting them (divert to voice mail), by lefting the call control system pre-screen the call or in a case where the user does not do anything, the call control system can be set to activate automatically after a predetermined number of rings or after predetermined time. Alternatively the computer program can be part of a profile logic software that changes the setting of ringing volume or tone, vibrating alert, call screening or other settings. However, the basic call control software after accepting incoming calls, can play pre-recorded or custom-recorded messages, and accept either DTMF responses from the caller, or voice response, to redirect the call appropriately. The call control software can also form an additional data connection to the calling terminal and provide a menu for a display of said calling terminal. The menu can e.g. give options for determining the urgency level by numbers or ask the caller to give other information relating to the call. The call control system software can be communicating with a rules-based system that determines the next action based on the responses of the caller and/or the context of the phone (local time, location, profile, etc.).

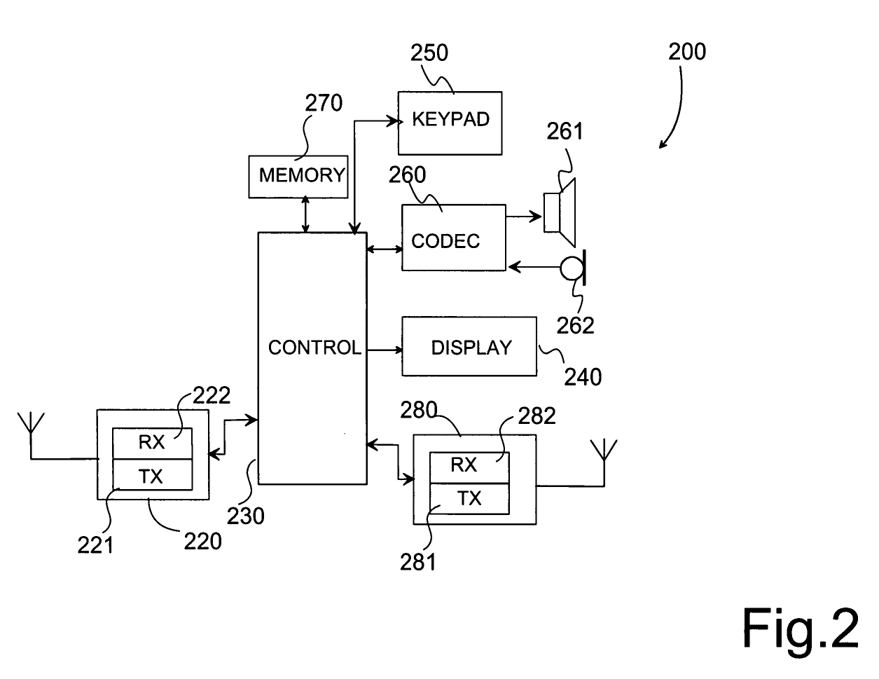

An example of a device is illustrated in FIG. 2. The device 200 comprises communication means 220 having a transmitter 221 and a receiver 222 or the device is connected to such. There can also be other communicating means 280 having a transmitter 281 and a receiver 282 as well. The first communicating means 220 can be adapted for telecommunication and the other communicating means 280 can be a kind of short-range communicating means, such as a Bluetooth™ system, a WLAN system (Wireless Local Area Network) or other system which suits local use and for communicating with another device. The device 200 can also comprise a display 240 for displaying visual information, e.g. caller information. In addition the device 200 may comprise an interaction means, such as a keypad 250 for inputting data, etc. In addition or instead of the keypad 250, the device can comprise a stylus where the display is a touch-screen display. The device 200 can also comprise audio means 260, such as an earphone 261 and a microphone 262 and optionally a codec for coding (and decoding, if needed) the audio information. The device 200 also comprises a control unit 230 for controlling functions, tasks and running applications in the device 200. The control unit 230 may comprise one or more processors (CPU, DSP). The device further comprises memory 270 for storing e.g. data, applications, computer program code, etc.

Instead of the mobile phones, the invention can be implemented on the network side. This implementation would require standardization for network servers to some degree, and it would not necessarily work when roaming. However, the basic idea of the invention is the same, whereby the implementation side should not be considered as limiting feature of this invention.

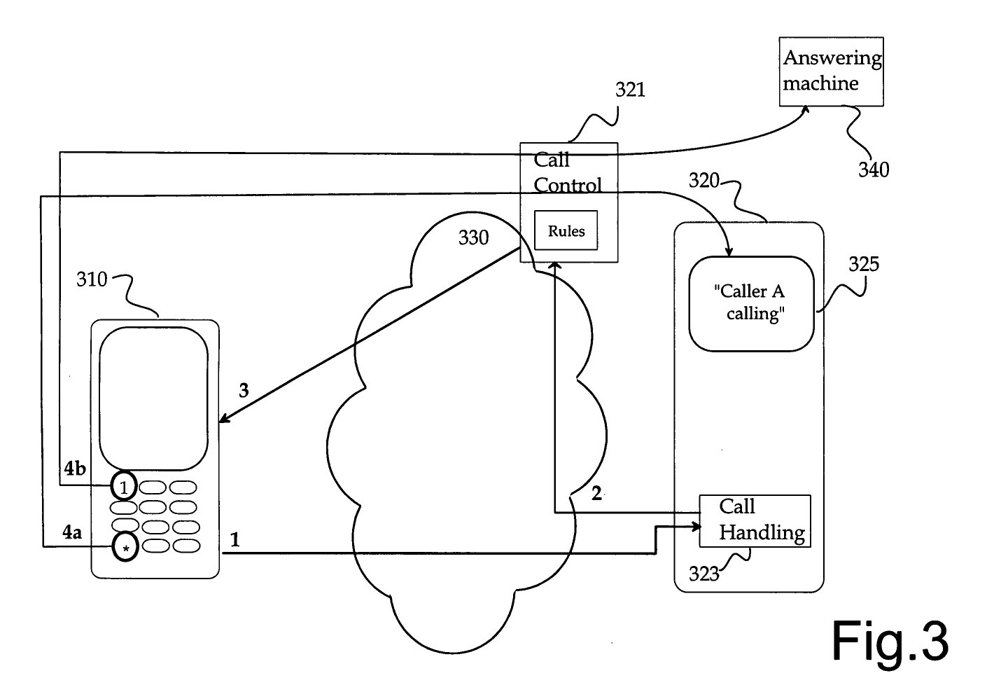

An example of a system, where the call control is implemented by a network element, is illustrated in FIG. 3. The method steps are illustrated in FIG. 3 by reference numbers 1-4b. The calling terminal 310 “Caller A” makes a call (1) to a terminal 320. Basic steps for handling an incoming call in receiving terminal 320 are not described any further, but what should be understood in this context, is that the call handling software 323 can determine the need for call control according to the context settings in the receiving terminal. If e.g. the terminal is set to silent profile, the call handling software is capable of directing (2) the incoming call to the call control system 321 locating—in this example—in reach of a network 330. The call control system 321 “answers” to the call, and provides (3) the voice dialog to the caller A. According to the options, in this example, the caller A can select either keybutton “1” or “*” depending on the importance of the call. Naturally, the keybuttons can be different than the ones of this example. Due to selection of keybutton “1”, the call is directed (4b) to an answering machine 340 to where the caller A can leave a message. As a result of selection of keybutton “*”, the call is directed (4a) to the receiving terminal 320, whereby the user of the receiving terminal 320 can see the caller information on a display 325 of said terminal 320.

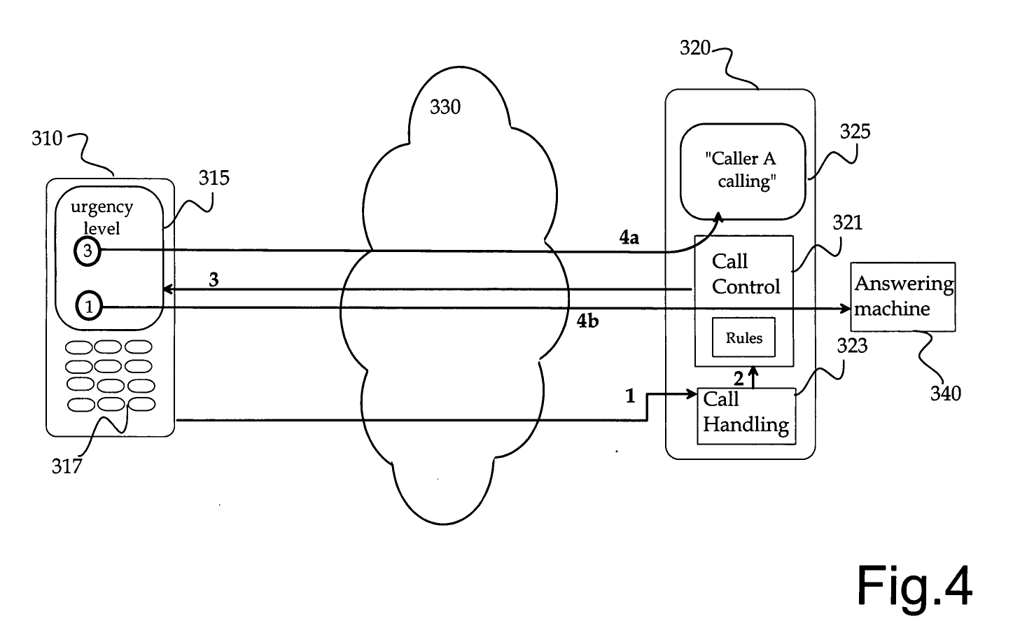

FIG. 4 illustrates a similar example of a system, but in this example the call control system 321 is configured into the receiving terminal 320. The process goes on similarly to the example in FIG. 3: the incoming call (1) is directed (2) to the call control system 321 in a case where the current context of the receiving terminal 320 requires it. In this example the call control system 321 forms an additional data connection (3) to the calling terminal 310 and provides a menu to a display 315 of the calling terminal 310. By using number or arrow keybuttons 317, the user can select an urgency level for the call. The call is further handled according to the selected urgency; with the highest urgency level the call is directed (4a) to the receiving terminal 320 and with other urgency level the call is directed (4b) to the answering machine 340. It will be appreciated by the skilled person, that the interactive menu can contain almost any information or interaction options. Therefore the simplified example of the textual dialog, illustrated in this example, should not be considered as limiting feature.

In FIGS. 3 and 4 two examples of the system are presented, one of which comprises a voice dialog and call control system outside of the receiving terminal, the other of which comprises a menu dialog and call control system in the receiving terminal itself. Any combination of these examples should be understood by the person skilled in the art. Therefore it will be clear that variations and modifications of the examples of the embodiments described are possible without departing from the scope of protection of the invention as set forth in the claims.

1. A method for controlling targeting calls, wherein a targeting call is pre-screened according to set of rules determined for the target device and an importance of said targeting call is determined, by means of which importance call diverting is decided.

2. The method according to claim 1, wherein the targeting call is pre-screened after certain rings.

3. The method according to claim 1, wherein the targeting call is pre-screened according to calling time.

4. The method according to claim 1, wherein determining the importance of said targeting call comprises steps for playing a message to the caller, which message allows the caller to provide an urgency level for his/her reason for calling.

5. The method according to claim 1, wherein determining the importance of said targeting call comprises steps for presenting a menu to the caller, which menu allows the caller to provide an urgency level for his/her reason for calling.

6. The method according to claim 1, wherein pre-screening of the targeting call is started according to a set of rules comprising at least one of the following information: profile, location, time, timezone.

7. The method according to claim 1, wherein the call is diverted to a voice messaging unless the caller indicates an urgency of the call.

8. A device for controlling communication comprising means for pre-screening a targeting call according to set of rules determined for said device, wherein said means are arranged to determine an importance of said targeting call, by means of which importance said means are configured to decide for call diverting.

9. The device according to claim 8, wherein said means are configured to pre-screen the targeting call after certain rings.

10. The device according to claim 8 wherein said means are configured to pre-screen the targeting call according to calling time.

11. The device according to claim 8, wherein said means are capable of playing a message to the caller which message allows the caller to provide an urgency level for his/her reason for calling, by means of which the means are capable of determining the importance of said call.

12. The device according to claim 8, wherein said means are capable of presenting a menu to the caller which menu allows the caller to provide an urgency level for his/her reason for calling, by means of which the means are capable of determining the importance of said call.

13. The device according to claim 8, comprising a set of rules, by means of which the means are capable of pre-screening the targeting call, said rules comprising at least one of the following information: profile, location, time, timezone.

14. The device according to claim 8, wherein the means are capable of detecting a keybutton press which keybutton is configured for urgency button, and diverting the call to a recipient.

15. The device according to claim 8, capable of controlling calls that target said device.

16. The device according to claim 8, capable of controlling calls targeting a communication device.

17. A device for controlling communication, comprising a call control system for pre-screening a targeting call according to set of rules determined for said device, wherein said call control system is arranged to determine an importance of said targeting call, by means of which importance said call control system is configured to decide for call diverting.

18. The device according to claim 17, wherein said call control system is configured to pre-screen the targeting call after a certain number of rings.

19. The device according to claim 17, wherein said call control system is configured to pre-screen the targeting call according to calling time.

20. The device according to claim 17, wherein said call control system is capable of playing a message to the caller which message allows the caller to provide an urgency level for his/her reason for calling, by means of which the call control system is capable of determining the importance of said call.

21. The device according to claim 17, wherein said call control system is capable of presenting a menu to the caller which menu allows the caller to provide an urgency level for his/her reason for calling, by means of which the call control system is capable of determining the importance of said call.

22. The device according to claim 17, comprising a set of rules, by means of which said call control system is capable of pre-screening the targeting call, said rules comprising some of the following information: profile, location, time, timezone.

23. The device according to claim 17, wherein said call control system is capable of detecting a keybutton press which keybutton is configured for urgency button, and diverting the call to a recipient.

24. The device according to claim 17, capable of controlling calls that target said device.

25. The device according to claim 17, capable of controlling calls targeting a communication device.

26. A calling device comprising means for initiating a call and, as a response to the initiated call, receiving a request for determining an importance of said call, whereby said calling device is capable of sending the determined importance as a response to the request.

27. A computer program product comprising computer readable instructions for controlling communication, wherein said instructions are configured to pre-screen a targeting call according to set of rules and to determine an importance of said targeting call, by means of which importance said instructions are configured to decide for a call diverting.

28. The computer program product according to claim 27 being stored on a medium.

29. A system for communication comprising at least a calling terminal and a receiving terminal and a communication network configured between them, said system further comprising means for pre-screening a call originating from said calling terminal according to set of rules, said rules being determined for the receiving terminal, wherein said means are further arranged to determine an importance of said call, by means of which importance said means are configured to decide for call diverting.

30. The system according to claim 29, wherein said means are capable of playing a message to the calling terminal which message allows a caller to provide an urgency level for his/her reason for calling, by means of which the means are capable of determining the importance of said call.

31. The system according to claim 29, wherein said means are capable of presenting a menu on a display of the calling device which menu allows a caller to provide an urgency level for his/her reason for calling, by means of which the means are capable of determining the importance of said call.
